(19) United States
(12) Patent Application Publication
(10) Pub. No.: US 2021/0101464 A1
(43) Pub. Date: Apr. 8, 2021

(54) VEHICLE SUBSTRUCTURE

(71) Applicant: HONDA MOTOR CO., LTD., Tokyo (JP)

(72) Inventors: Yuki MATSUSHIMA, Wako-shi (JP); Chihiro SAKURADA, Wako-shi (JP); Koichi TAKAHASHI, Wako-shi (JP); Yusuke OKAMOTO, Wako-shi (JP)

(21) Appl. No.: 17/062,818

(22) Filed: Oct. 5, 2020

(30) Foreign Application Priority Data
Oct. 3, 2019 (JP) 2019-182869

(51) Int. Cl. B60K 1/04; B62D 25/20; B62D 25/02; B60N 2/005

(52) U.S. Cl. CPC B60K 1/04; B62D 25/2036; B60K 2001/0438; B60N 2/005; B62D 25/025

(57) ABSTRACT

A vehicle substructure prevents a side sill, when a load is inputted, from being turned. The vehicle substructure includes a battery case having a battery housed therein. The battery case includes a bottomed case pan having an opening at a top thereof, and a case cover to close the opening of the case pan. The case cover vertically has a top plate at a top, a bottom plate at a bottom, and partitions disposed between the top and bottom plates to couple the top plate with the bottom plate and linearly extending in a vehicle width direction so as to be substantially in parallel to each other. Both ends in the vehicle width direction of the case cover are connected to a pair of right and left side sills disposed on both the right and left sides in the vehicle width direction and extending in a vehicle front-rear direction.

### CROSS-REFERENCE TO RELATED APPLICATION

This application claims the benefit of priority to Japanese Patent Application No. 2019-182869 filed on 3 Oct. 2019, the disclosures of all of which are hereby incorporated by reference in their entireties.

### TECHNICAL FIELD

The present invention relates to a substructure of a vehicle such as an electric vehicle.

### BACKGROUND OF THE INVENTION

Japanese Patent No. 5541100 (hereinafter, referred to as Patent Document 1), for example, discloses a battery pack tray substructure including a battery house to house batteries and having an opening to be closed by a battery pack cover.

### SUMMARY OF THE INVENTION

### Problems to be Solved

However, the battery pack tray substructure disclosed in Patent Document 1 has a risk of a side sill being turned, when a lateral collision load has been inputted to a vehicle, for example, due to the lateral collision load given to the side sill.

The present invention has been made in view of the above-identified problem and is intended to provide a vehicle substructure capable of preventing a side sill, when a load is inputted, from being turned.

### Solution to Problem

In order to achieve the above-described objective, the present invention provides a vehicle substructure including a battery case having a battery housed therein, wherein the battery case includes a bottomed case pan having an opening at a top thereof, and a case cover to close the opening of the case pan, wherein the case cover vertically has a top plate located at a top thereof, a bottom plate located at a bottom thereof, and partitions disposed between the top plate and the bottom plate to couple the top plate with the bottom plate and linearly extending in a vehicle width direction so as to be substantially in parallel to each other, and both ends in the vehicle width direction thereof are connected to a pair of right and left side sills disposed on both a right side and a left side in the vehicle width direction of a vehicle and extending in a vehicle front-rear direction.

### Advantageous Effects of the Invention

The present invention provides a vehicle substructure capable of preventing a side sill, when a load is inputted, from being turned.

### BRIEF DESCRIPTION OF DRAWINGS

FIG. 1 is a bottom view of a vehicle having a vehicle substructure according to an embodiment of the present invention;

FIG. 2 is a lateral view of the vehicle in FIG. 1, partially cross-sectional in a vehicle front-rear direction;

FIG. 3 is a perspective view of the vehicle in FIG. 1, partially cutaway in the vehicle front-rear direction;

FIG. 4 is a perspective view of the vehicle in FIG. 1, partially cutaway in a vehicle width direction;

FIG. 5 is a top view of the vehicle in FIG. 1;

FIG. 6 is a bottom view of a case cover of a battery case;

FIG. 7 is a lateral view of the case cover in FIG. 6, partially cutaway in the vehicle front-rear direction;

FIG. 8 is a partially enlarged bottom view of the case cover in FIG. 1;

FIG. 9 is a schematic cross-sectional view indicating a lateral collision load inputted to a side sill being transmitted inward in the vehicle width direction along the case cover;

FIG. 10 is a cross sectional view of a suspending structure to suspend and support a battery B;

FIG. 11 is a partially transparent perspective view of the suspending structure; and

FIG. 12 is a plan view of a battery cover in a related art studied by the inventors.

### EMBODIMENTS OF THE INVENTION

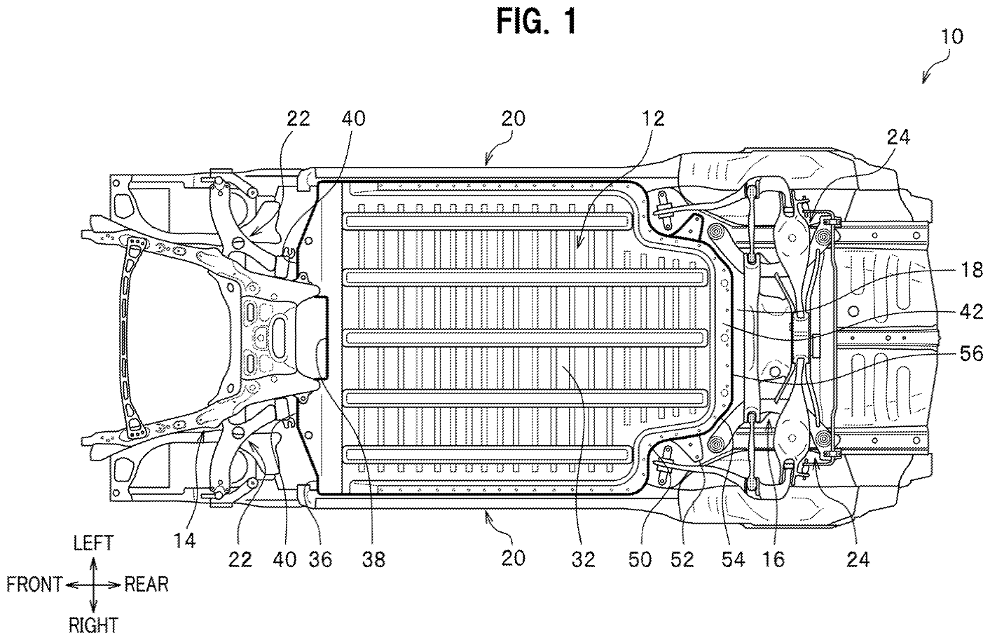

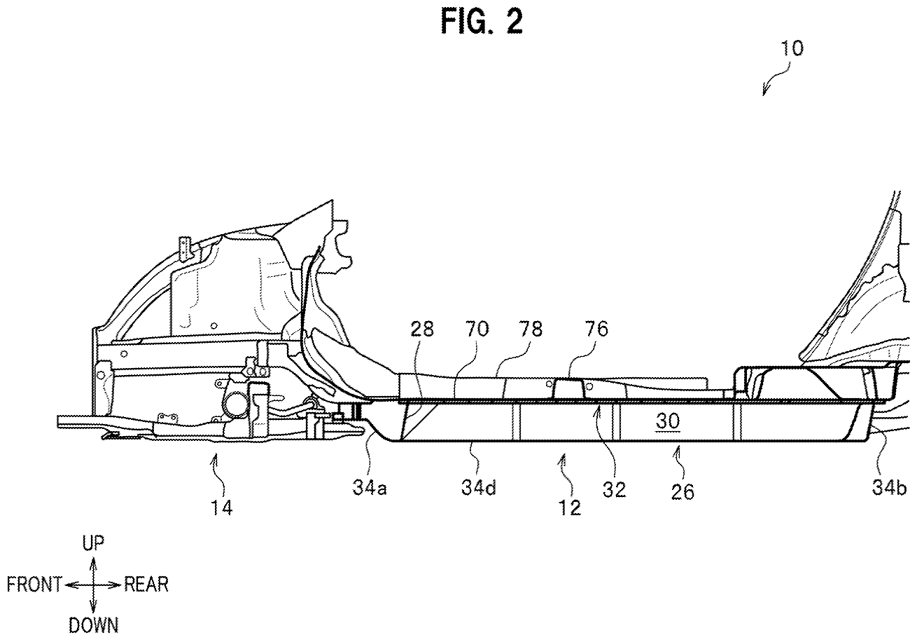

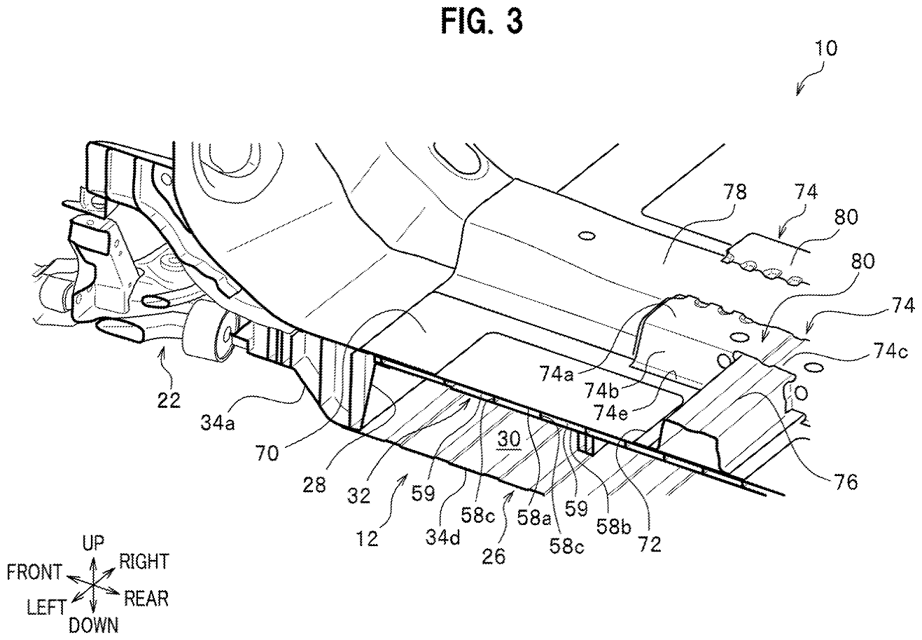

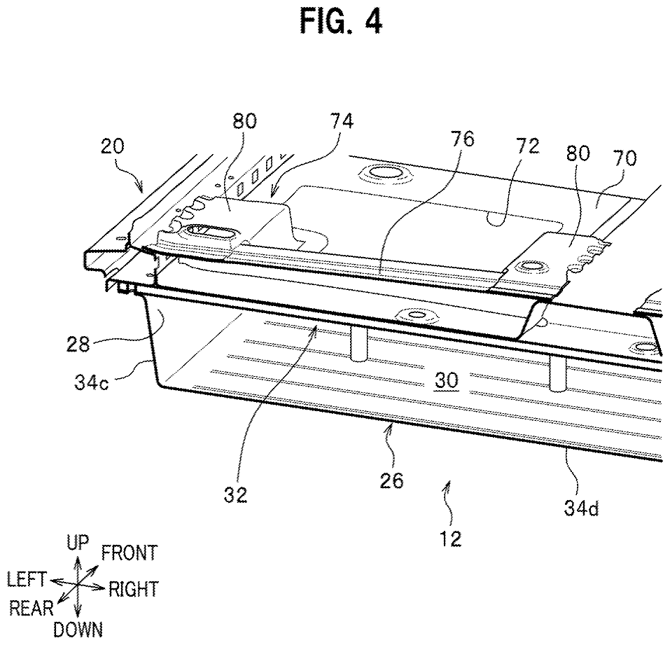

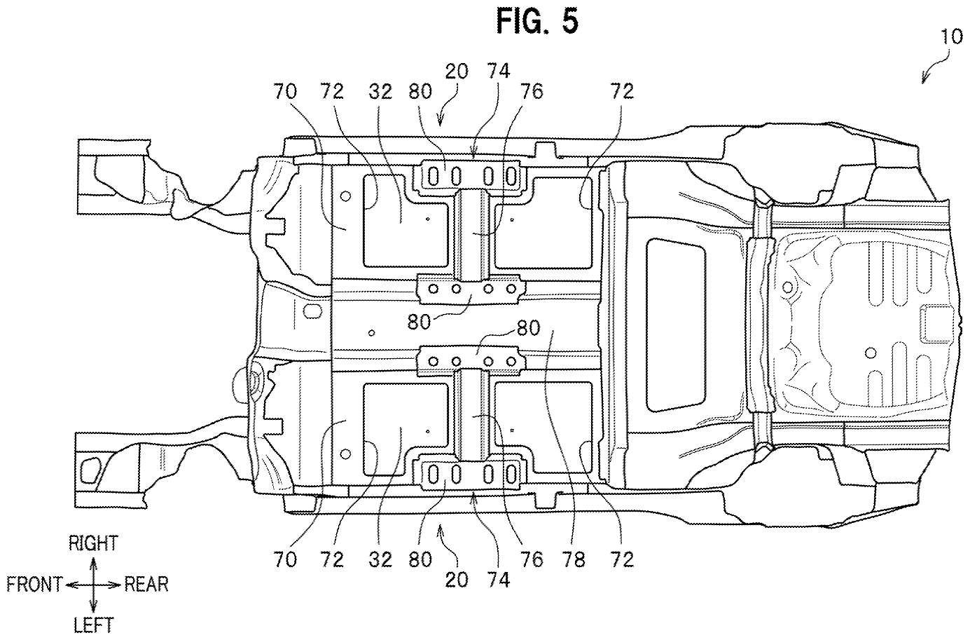

Hereinafter, an embodiment of the present invention is described in detail, with reference to the drawings as required. FIG. 1 is a bottom view of a vehicle having a vehicle substructure according to an embodiment of the present invention; FIG. 2 is a lateral view of the vehicle in FIG. 1, partially cross-sectional in a vehicle front-rear direction; FIG. 3 is a perspective view of the vehicle in FIG. 1, partially cutaway in the vehicle front-rear direction; FIG. 4 is a perspective view of the vehicle in FIG. 1, partially cutaway in a vehicle width direction; and FIG. 5 is a top view of the vehicle in FIG. 1.

Note that “front-rear” indicates the vehicle front-rear direction, “right-left” indicates the vehicle width direction (right-left direction), and “up-down” indicates a vehicle up-down direction (vertically up-down direction), respectively.

A vehicle substructure according to the embodiment of the present invention is applied to a vehicle 10 such as an electric vehicle, a hybrid vehicle, a fuel battery vehicle. The vehicle 10 includes a high-voltage battery (not shown), an electric motor (motor for travelling), and electric equipment such as a PDU (Power Drive Unit) to control and supply power from the battery to the electric motor.

The vehicle 10 includes a battery case 12 as an energy source for driving the electric motor, as shown in FIGS. 1 and 2. The battery case 12 is disposed under a center in the vehicle front-rear direction of the vehicle between a front subframe 14 and a rear subframe 16, in a bottom view. A front end, when installed in the vehicle, of the battery case is coupled to a rear end, when installed in the vehicle, of the front subframe 14. A rear end, when installed in the vehicle, of the battery case is coupled to a rear vehicle body 18 as a vehicle body member. Both ends in the vehicle width direction of the battery case 12 are respectively coupled to undersurfaces of a pair of right and left side sills 20.

In addition, as shown in FIG. 1, a pair of right and left front suspension mechanisms 22 is disposed in front of the battery case 12, in the vehicle, on both sides in the vehicle width direction. Likewise, a pair of right and left rear suspension mechanisms 24 is disposed behind the battery case 12, in the vehicle, on both sides in the vehicle width direction. Note that the rear suspension mechanisms 24 are each configured as a trailing suspension including a trailing arm.

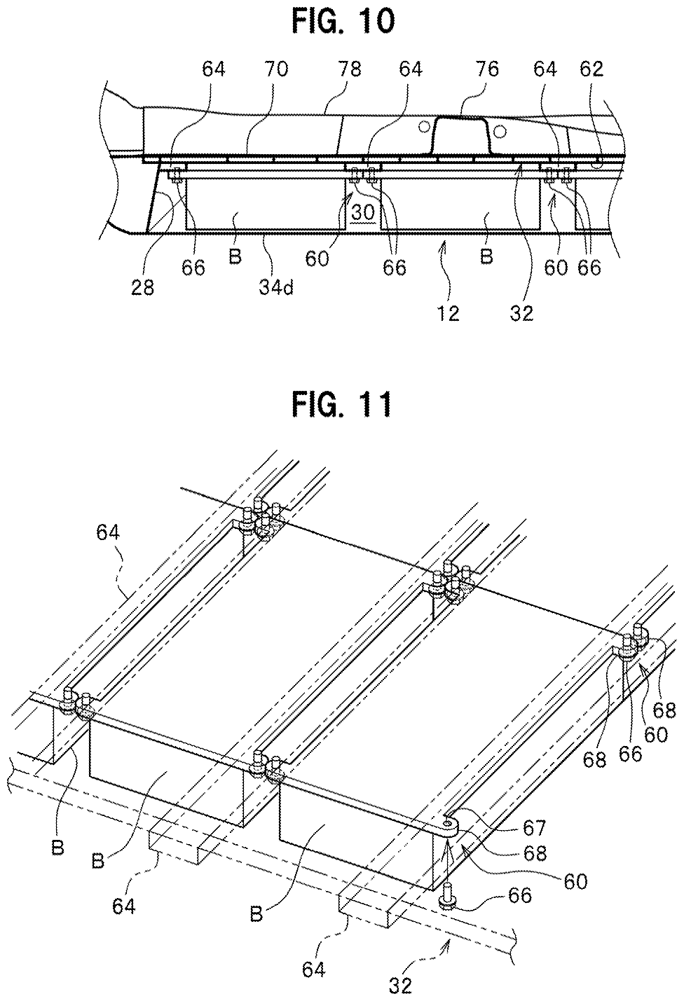

The battery case 12 includes a bottomed case pan 26 having an opening 28 at a top thereof, and a case cover 32 to close and seal the opening 28 of the case pan 26 to define a chamber 30, as shown in FIGS. 2 and 3. The chamber 30 of the battery case 12 houses a plurality of batteries B (see FIGS. 10, 11). Note that FIG. 1 shows the battery case 12 with the case pan 26 removed, that is, the case cover 32, as viewed from the bottom.

As shown in FIG. 2, the case pan 26 is formed to have a substantially rectangular shape, in a lateral view, and includes a front wall 34a at a front thereof in the vehicle, a rear wall 34b at a rear thereof in the vehicle, a pair of right and left side walls 34c (see FIG. 4) on both sides in the vehicle width direction thereof, and a bottom wall 34d to couple lower ends of the front wall 34a, rear wall 34b, and pair of right and left side walls 34c.

The case cover 32 is made of a plate in a flat plate shape formed with extrusion molding by an extruder (not shown), to have a substantially rectangular shape (see FIGS. 3 and 4) in a planar view.

As shown in FIG. 1, the case cover 32 is formed, at a front end 36 thereof, with a recess 38 located at the center in the vehicle width direction and dented (set back) rearward. A pair od right and left protrusions 40, protruding frontward and coupled to the front suspension mechanism 22, are provided on both the right and left sides of the recess 38. Note that a reference numeral 76 indicates a vehicle body cross member, and a reference numeral 78 indicates a center tunnel.

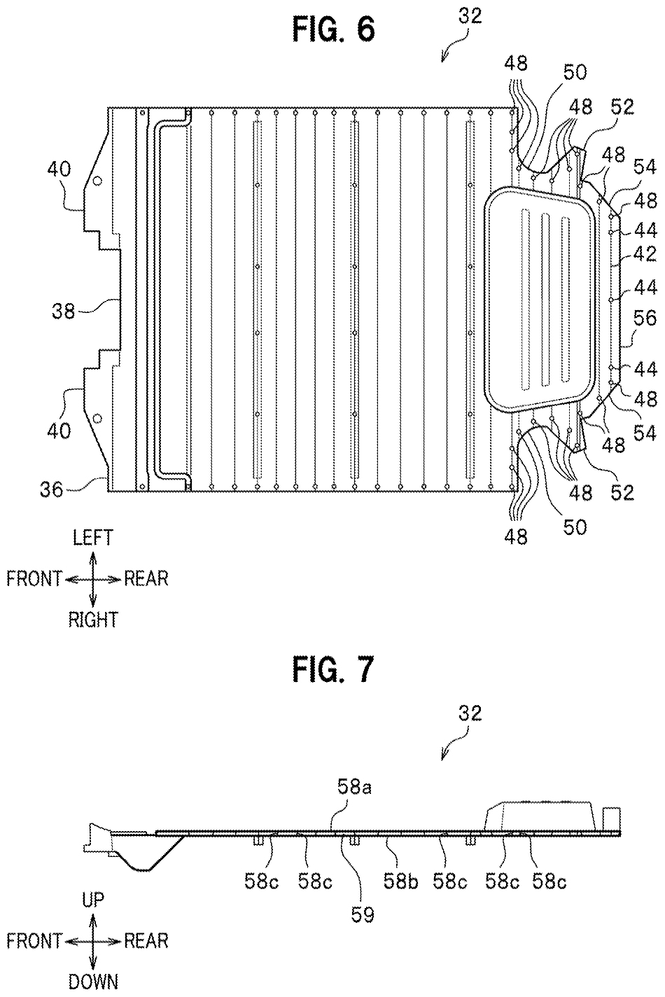

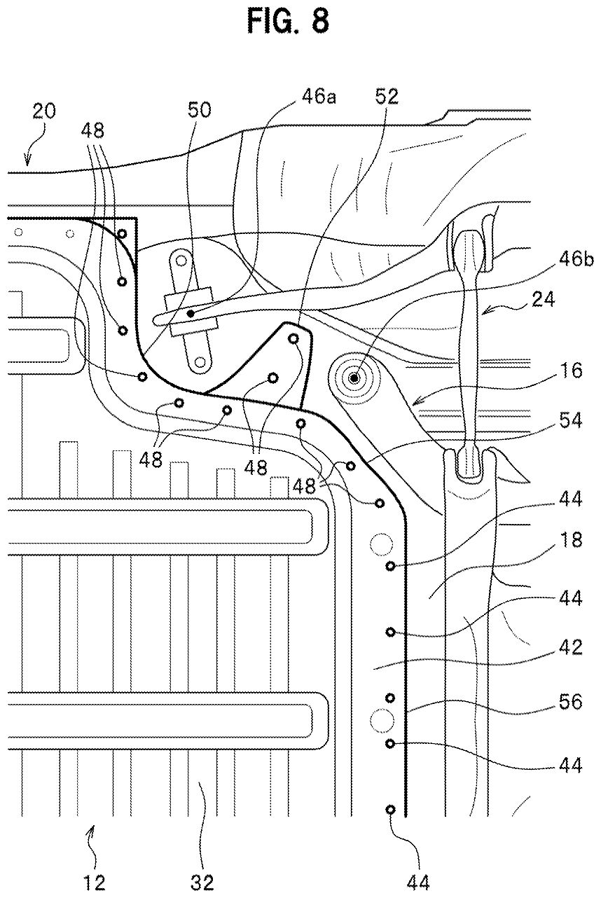

FIG. 6 is a bottom view of the case cover of the battery case, FIG. 7 is a lateral view of the case cover in FIG. 6, partially cutaway in the vehicle front-rear direction, and FIG. 8 is a partially enlarged bottom view of the case cover in FIG. 1. Note that FIG. 8 shows a left side in the vehicle width direction of the case cover 32, but does not show a right side in the vehicle width direction of the case cover 32.

A rear end 42 of the case cover 32 has fixed points 44 to be fixed to the rear vehicle body 18 as a vehicle body member, as shown in FIGS. 6 and 8. The fixed points 44 include embracing fixed points 48 arranged so as to embrace input points 46a, 46b for a rear collision load inputted from the rear end 42, that is, so as to partially surround the input points 46a, 46b. In other words, in the present embodiment, the embracing fixed points 48 are arranged in the vicinity of the input point 46a having a rear collision load inputted from the suspension mechanism 24 and the input point 46b having a rear collision load inputted from the rear subframe 16, to cover portions of the rear end 42 toward which a rear collision load is to be inputted, with respect to the input points 46a, 46b, that is, a frontward portion and an inward portion in the vehicle width direction.

The rear end 42 of the case cover 32 includes a pair of right and left inward-curved portions 50, a pair of right and left protruding portions 52, a pair of right and left skewing portions 54, and a straight portion 56. The inward-curved portions 50 are located on both the right and left sides in the vehicle width direction on the rear side of the vehicle so as to be recessed inward in the vehicle width direction, in a planar view, to have a substantially arc shape. The protruding portions 52 are arranged to continue to rear regions of the inward-curved portions 50 and obliquely protrude outward in the vehicle width direction. The pair of protruding portions are joined to each other via the skewing portions 54 by the straight portion 56 extending in the vehicle width direction.

As shown in FIG. 7, the case cover 32 has a sandwich structure with a top plate 58a, a bottom plate 58b, and partitions 58c. That is, the case cover 32 has, in the up-down direction, the top plate 58a located at a top thereof, the bottom plate 58b located at a bottom thereof, and the partitions 58c located between the top plate 58a and the bottom plate 58b to couple the top plate 58a with the bottom plate 58b. The partition 58c linearly extends in the vehicle width direction. The partitions 58c adjacent to each other in the vehicle front-rear direction define therebetween a hollow slit 59 (see FIGS. 3 and 7) to extend in the vehicle width direction.

Additionally, the top surface of the case cover 32 is coupled, on both ends in the vehicle width direction thereof, with the undersurfaces of the pair of right and left side sills 20 disposed on both the right and left sides in the vehicle width direction, respectively, and extending in the vehicle front-rear direction.

A mold (ferrule) for extrusion molding, not shown, has a shape fitted to a vertical cross section of the case cover 32 (see FIG. 3, for example). This allows for integrally forming the top plate 58a, the bottom plate 58b, and the partitions 58c by extrusion molding.

Note that a distance between the adjacent partitions 58c of the case cover 32 vanes in the vehicle front-rear direction. This is described in detail below.

In addition, a top surface of the case cover 32 has no such frames, that bulge upward, provided at front and rear edges and right and left edges thereof, to have a flat surface as with the rest thereof. That is, the top surface of the case cover 32 is flat at the front and rear edges and the right and left edges thereof.

FIG. 10 is a cross sectional view of a suspending structure to suspend and support a battery B, and FIG. 11 is a partially transparent perspective view of the suspending structure. The case cover 32 is provided on the undersurface thereof with a suspending structure 60 to suspend and support the battery B, as shown in FIGS. 10 and 11. The suspending structure 60 includes cross bars 64 fixed to a ceiling surface 62, as the undersurface of the case cover 32, at predetermined intervals in the vehicle front-rear direction and extending in the vehicle width direction, and bolts 66 to be threaded into thread holes provided in the cross bars 64. The battery B is provided at a top thereof with mounting portions 68 protruding in the vehicle front-rear direction and having bolt insertion holes 67.

As shown in FIG. 11, the bolts 66 are inserted into the bolt insertion holes 67 of the mounting portions 68 of the battery B and threaded portions of the bolts 66 are threaded into threaded holes in the cross bars 64 to suspend and support the batteries B on the undersurface of the case cover 32 having high rigidity and strength.

Further, the case cover 32 has a floor panel 70 disposed on the top surface thereof, as shown in FIGS. 3 to 5. The floor panel 70 is provided with panel openings 72 at part of areas vertically overlaying the case cover 32.

The vehicle 10 further includes the pair of right and left side sills 20, right and left seat frames 74, and the vehicle body cross members 76 to connect the pair of right and left side sills with each other, as shown in FIG. 5. The vehicle body cross member 76 has a hat shape in an axial cross section (see FIG. 3) and has bottom flanges on both sides thereof joined to the top surface of the floor panel 70.

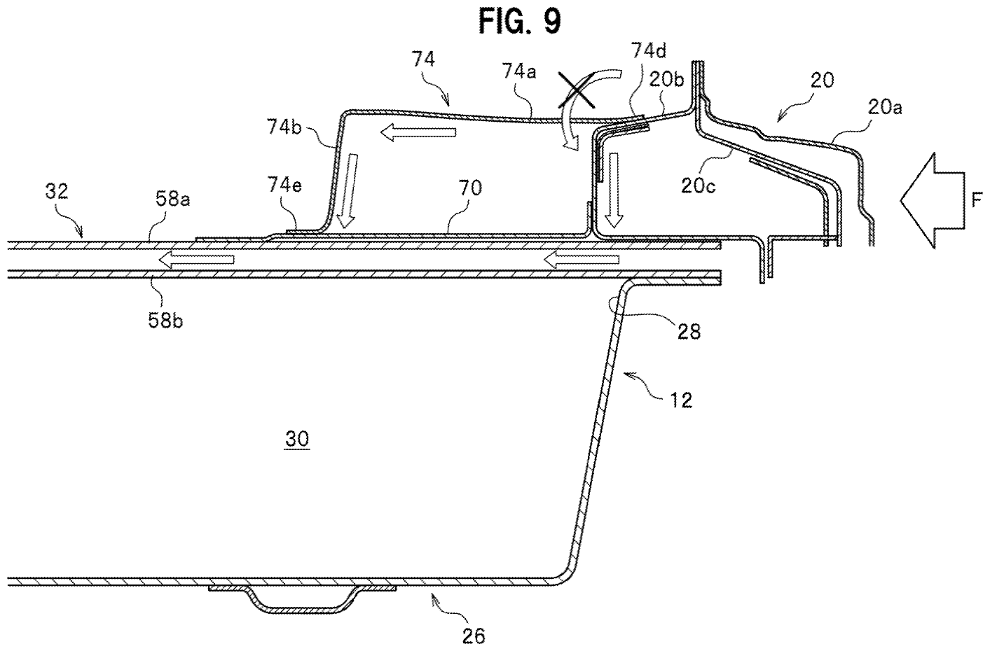

The side sills 20 are disposed on both the right and left sides in the vehicle width direction, and extend in the vehicle front-rear direction. As shown in FIG. 9, the side sill 20 includes an outer side sill 20a disposed on an outer side in the vehicle width direction, an inner side sill 20b disposed on an inner side in the vehicle width direction, and a side sill stiffener 20c interposed between the outer side sill 20a and the inner side sill 20b.

The seat frame 74 is disposed between the side sill 20 and the center tunnel 78, and extends in the vehicle front-rear direction across the vehicle body cross member 76, as shown in FIG. 5. The right and left seat frames 74 are disposed on the right and left sides in the vehicle width direction of the center tunnel 78 at the center, and each include a pair of frame members 80 facing each other in the vehicle width direction.

A vertical cross section of the seat frame 74 has a substantially L-shape (see FIG. 9 to be described below). The seat frame 74 includes a horizontal plate 74a extending substantially horizontally, and a vertical wall 74b curved at an inner end in the vehicle width direction of the horizontal plate 74a and extending downward. A center portion 740 in the vehicle front-rear direction of the horizontal plate 74a is joined to the vehicle body cross member 76. An outer end 74d in the vehicle width direction of the horizontal plate 74a is joined to the inner side sill 20b of the side sill 20. A lower end 74e of the vertical wall 74b is joined to a top surface of the floor panel 70.

The vehicle 10 having the vehicle substructure of the present embodiment is basically configured as described above, and advantageous effects thereof are described next. FIG. 9 is a schematic cross-sectional view indicating a lateral collision load inputted to the side sill being transmitted inward in the vehicle width direction along the case cover.

The case cover 32 of the present embodiment has a sandwich structure formed of the top plate 58a, the bottom plate 58b, and the partitions 58c, to improve rigidity and strength in the vehicle width direction of the case cover 32. When a lateral collision load F is inputted to the side sill 20, for example, the lateral collision load F is efficiently transmitted inward in the vehicle width direction along the case cover 32 having high rigidity and strength (see FIG. 9).

In addition, the case cover 32 of the present embodiment has a sandwich structure formed of the top plate 58a, the bottom plate 58b, and the partitions 58c, to have high rigidity and strength, even against a bending load about an axis in the vehicle front-rear direction. Additionally, the pair of right and left side sills 20, respectively disposed on both the right and left sides in the vehicle width direction and extending in the vehicle front-rear direction, is coupled on the undersurface thereof with the case cover 32. This allows, in the present embodiment, for preventing the side sill 20 and the case cover 32 from being vertically displaced, even against the lateral collision load F transmitted from the side sill 20 downward to the case cover 32. As a result, in the present embodiment, the side sill 20 is prevented from being turned at the time of a lateral collision load having been inputted. This allows, in the present embodiment, for retaining soundness of opening/closing doors, not shown, even when the lateral collision load F is inputted to the side sill 20.

Further, the case cover 32 of the present embodiment is formed by extrusion molding. This allows, in the present embodiment, for integrally forming the top plate 58a, bottom plate 58b, and partitions 58c of the case cover 32, to further improve rigidity and strength of the case cover 32. The present embodiment thus further prevents the side sill 20 from being turned at the time of a lateral collision load having been inputted.

Still further, in the present embodiment, the floor panel 70 is arranged on the case cover 32 and the floor panel 70 is provided with the panel openings 72 (see FIGS. 3 to 5) at portions thereof vertically overlapping with the case cover 32. The panel openings 72 are provided in the present embodiment to avoid a double bottom made with the floor panel 70 and the case cover 32. This allows for effectively utilize a space between the ground and the floor panel 70 and reducing noise vibration due to a double bottom to improve rigidity and strength of the vehicle substructure. Additionally, the case cover 32 of the present embodiment, having higher rigidity and strength as compared with that of a prior art, plays by itself a role of the floor panel 70 to achieve reduction in weight.

Still further, the pair of right and left seat frames 74, adjacent to the side sills 20 and extending in the vehicle front-rear direction, is provided in the present embodiment, to transmit the lateral collision load F inputted from the side sill 20 via the frame seats 74 to the case cover 32. This allows, in the present embodiment, for improving efficiency of absorbing a lateral collision load.

Still further, the seat frame 74 of the present embodiment has a vertical cross section in a substantially L-shape to include the horizontal plate 74a extending substantially horizontally, and the vertical wall 74b curved at an inner end in the vehicle width direction of the horizontal plate 74a and extending downward, and an outer end in the vehicle width direction of the horizontal plate 74a is joined to the side sill 20 while a lower end of the vertical wall 74b is joined to a top surface of the floor panel 70. This allows, in the present embodiment, for connecting the side sill 20 with the floor panel 70 by the seat frame 74 having a vertical cross section in a substantially L-shape, to transmit the lateral collision load F given in the vehicle width direction onto the side sill 20 (a load given in a direction of turning the side sill 20) via the floor panel 70 to the case cover 32. As a result, in the present embodiment, the side sill 20 is further prevented from being turned at the time of a lateral collision load having been inputted.

In the present embodiment, a distance between the partitions 58c adjacent in the vehicle front-rear direction to each other varies in the vehicle front-rear direction.

That is, a distance between the adjacent partitions 58c is varied in the vehicle front-rear direction to allow the case cover 32 of the present embodiment to have different strength between regions thereof. The case cover 32 may have a protected region having high rigidity and strength and a collapsed region having lower rigidity and strength than the protected region, for example, based on this strength difference. As a result, a mode is controllable in the present embodiment when a collision load is inputted to the case cover 32.

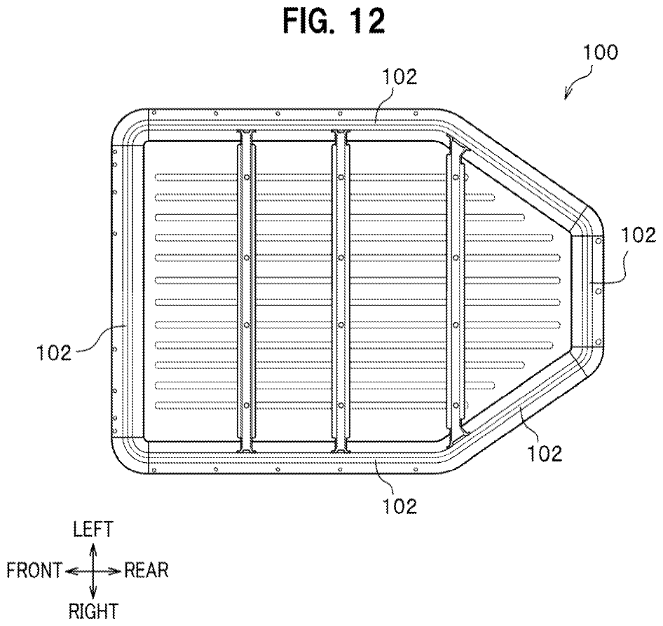

Still further, the top surface of the case cover 32 of the present embodiment is flat at the edges in the vehicle front-rear direction and the edges in the vehicle width direction, to have no need for a frame 102 (see FIG. 12) provided at the periphery of a case cover 100 in a related art. This allows, in the present embodiment, for satisfying legally required collapsing performance as well as simplifying manufacturing process of the case cover 32 so as to be easily manufactured.

Still further, the case cover 32 of the present embodiment, having higher rigidity and strength by itself, as compared with that of a related art, to allow for providing the suspending structure 60 on the undersurface of the case cover 32 to suspend and support the battery B. The suspending structure 60 includes the cross bars 64 extending in the vehicle width direction and fixed to the undersurface of the case cover 32 at predetermined intervals in the vehicle front-rear direction. The cross bars 64 are provided therein with thread holes, and the battery B is provided at a top thereof with the mounting portions 68 protruding in the vehicle front-rear direction and having the bolt insertion holes 67.

In the present embodiment, the battery B is suspended and supported on the undersurface of the case cover 32 having high rigidity and strength, to have no need of any supporting member under the battery B. In a prior art, a bracket (not shown) to support the battery B from under the battery is used, for example, but such a bracket is unnecessary in the present embodiment to allow for reducing parts in number and weight, to have a lower cost.

Still further, the case cover 32 of the present embodiment is provided at the rear end thereof with the fixed points 44 to be fixed to the rear vehicle body 18 as a vehicle body member. The fixed points 44 include the embracing fixed points 48 arranged so as to embrace the input points 46a, 46b of a rear collision load (see FIG. 8).

With such a structure, the input point 46a having a rear collision load inputted from the suspension mechanism 24 and the input point 46b having a rear collision load inputted from the rear subframe 16 are embraced in the present embodiment by the embracing fixed points 48, to improve rigidity and strength of the rear vehicle body. Additionally, a load inputted from the suspension mechanism 24 and a load inputted from the rear subframe 16 are efficiently transmitted via the rear end 42 to the case cover 32.

### LIST OF REFERENCE SIGNS

10: vehicle, 12: battery case, 20: side sill, 26: case pan, 28: opening, 30: chamber, 32: case cover, 42: rear end, 44: fixed point, 46a, 46b: input point, 48: embracing fixed point, 58a: top plate, 58b: bottom plate, 58c: partition, 64: cross bar, 67: bolt insertion hole, 68: mounting portion, 70: floor panel, 72: panel opening, 74: seat frame, 74a: horizontal plate, 74b: vertical wall, F: lateral collision load, and B: battery.

What is claimed is:

1. A vehicle substructure comprising a battery case having a battery housed therein,
wherein the battery case includes a bottomed case pan having an opening at a top thereof, and a case cover to close the opening of the case pan,
wherein the case cover vertically has a top plate located at a top thereof, a bottom plate located at a bottom thereof, and partitions disposed between the top plate and the bottom plate to couple the top plate with the bottom plate and linearly extending in a vehicle width direction so as to be substantially in parallel to each other, and
both ends in the vehicle width direction of the case cover are connected to a pair of right and left side sills disposed on both a right side and a left side in the vehicle width direction of a vehicle and extending in a vehicle front-rear direction.

2. The vehicle substructure as claimed in claim 1, wherein
the case cover is formed by extrusion molding.

3. The vehicle substructure as claimed in claim 1, wherein
a floor panel is arranged on the case cover and
the floor panel is provided with panel openings at portions thereof vertically overlapping with the case cover.

4. The vehicle substructure as claimed in claim 3, further comprising:
a pair of right and left seat frames, adjacent to the side sills and extending in the vehicle front-rear direction,
wherein the seat frames each have a vertical cross section in a substantially L-shape to include a horizontal plate extending substantially horizontally, and a vertical wall curved at an inner end in the vehicle width direction of the horizontal plate and extending downward,
wherein an outer end in the vehicle width direction of the horizontal plate is joined to the side sill and
a lower end of the vertical wall is joined to a top surface of the floor panel.

5. The vehicle substructure as claimed in claim 1, wherein
a distance between the partitions adjacent in the vehicle front-rear direction to each other varies in the vehicle front-rear direction.

6. The vehicle substructure as claimed in claim 1, wherein
a top surface of the case cover is flat at edges in the vehicle front-rear direction and edges in the vehicle width direction.

7. The vehicle substructure as claimed in claim 1, wherein
the case cover has cross bars, extending in the vehicle width direction, fixed to an undersurface thereof at predetermined intervals in the vehicle front-rear direction, wherein the cross bars are provided therein with thread holes, and
the battery is provided at a top thereof with the mounting portions protruding in the vehicle front-rear direction and having bolt insertion holes.

8. The vehicle substructure as claimed in claim 1, wherein
the case cover is provided at a rear end thereof with fixed points to be fixed to a rear vehicle body as a vehicle body member,
wherein the fixed points include embracing fixed points arranged so as to embrace input points of a rear collision load.
